(19) United States
(12) Patent Application Publication
(10) Pub. No.: US 2005/0050111 A1
(43) Pub. Date: Mar. 3, 2005

(54) Digital data archiving apparatus

(76) Inventor: Andrej A. Sensnovis, Wayland, MI (US)

Correspondence Address: Miller, Canfield, Paddock and Stone P.L.C.;c/o Robert Kelley Roth, Suite 2500, 150 West Jefferson Ave, Detroit, MI, 48226, US

(21) Appl. No.: 10/909,244

(22) Filed: Jul. 30, 2004

Related U.S. Application Data
(60) Provisional application No. 60/491,913, filed on Aug. 1, 2003.

(51) Int. Cl. G06F 17/30

(52) U.S. Cl. 707/203

(57) ABSTRACT

A digital data archiving apparatus comprises a hard drive, a flash memory reader/writer adapted to read digital data on a memory card and copy the digital data onto the hard drive, a data recording device adapted to receive the digital data and copy the data to a data storage device, and a display which presents messages including a first message to insert a memory card into the flash memory reader/writer and a second message to insert a data storage device into the data recording device. The first message is presented on the display and in response to the first message a memory card is inserted into the flash memory reader/writer and the digital data is directly copied to the hard drive, and then the second message is presented on the display and in response to the second message a data storage device is inserted into the data recording device and the digital data is directly copied to the data storage device.

### RELATED APPLICATION

This application claims priority benefit of U.S. provisional patent application No. 60/491,913 filed on Aug. 1, 2003.

### FIELD OF THE INVENTION

This invention relates to a digital data archiving system, and more particularly, to a digital data archiving system suitable for installation as a kiosk or in a stand alone display device.

### BACKGROUND OF THE INVENTION

Digital devices such as video recorders, digital cameras, video cameras, personal digital assistants (PDAs), portable music jukeboxes (MP3 players) and cell phones, etc., have seen widespread adoption by consumers. Such devices have been found by consumers to be quite useful in recording data of all kinds, including, for example, images such as photos of family and friends and of special events. The data may be stored on a variety of flash-memory type media devices, such as a compact-flash, memory card. The data on this card can then be transferred to a storage device such as a computer or laptop or other similar device for future archiving, permanent storage, further viewing and/or distribution, etc.

A problem occurs when using one of these digital data recording devices in a place remote from a storage device. For example, when on vacation at a national park a consumer may want to use a digital camera to take a large number of digital photos, but when the flash memory card is full, no more photos can be taken until the digital data on the memory card is transferred to another storage device and the flash memory card is erased. A consumer can bring a laptop along with him on vacation, if the consumer owns one, but this is not especially desirable in many situations where it is desired to travel with as few extra items as possible.

It would be highly desirable to provide a digital data archiving apparatus at remote locations which can store digital data in a convenient medium, and thereby allow consumers to use their digital devices continuously, even in remote areas.

### SUMMARY OF THE INVENTION

In accordance with a first aspect, a digital data archiving apparatus comprises a hard drive, a flash memory reader/writer adapted to read digital data on a memory card and copy the digital data onto the hard drive, a data recording device adapted to receive the digital data and copy the data to a data storage device, and a display which presents messages including a first message to insert a memory card into the flash memory reader/writer and a second message to insert a data storage device into the data recording device, wherein the first message is presented on the display and in response to the first message a memory card is inserted into the flash memory reader/writer and the digital data is directly copied to the hard drive, and then the second message is presented on the display and in response to the second message a data storage device is inserted into the data recording device and the digital data is directly copied to the data storage device. In accordance with another aspect, a digital data archiving device is used to sell advertising and can provide an accounting of the number of times digital data is copied.

From the foregoing disclosure and the following more detailed description of various preferred embodiments it will be apparent to those skilled in the art that the present invention provides a significant advance in the technology and art of digital data storage systems. Additional features and advantages of various preferred embodiments will be better understood in view of the detailed description provided below.

### BRIEF DESCRIPTION OF THE DRAWINGS

FIG. 1 is a front view of a digital data archiving apparatus in accordance with a preferred embodiment.

FIG. 2 is a flow chart showing a method of archiving digital data in accordance with a preferred embodiment.

FIG. 2A corresponds to the portion of the flow chart labeled “2A” in FIG. 2.

FIG. 2B corresponds to the portion of the flow chart labeled “2B” in FIG. 2.

It should be understood that the appended drawings are not necessarily to scale, presenting a somewhat simplified representation of various preferred features illustrative of the basic principles of the invention. Certain features of the illustrated embodiments may have been enlarged or distorted relative to others to facilitate visualization and clear understanding. In particular, thin features may be thickened, for example, for clarity of illustration. All references to direction and position, unless otherwise indicated, refer to the orientation illustrated in the drawings.

### DETAILED DESCRIPTION OF CERTAIN PREFERRED EMBODIMENTS

It will be apparent to those skilled in the art, that is, to those who have knowledge or experience in this area of technology, that many uses and variations are possible for the digital data archive system disclosed here. The following detailed discussion of various alternative and preferred features and embodiments will illustrate the general principles of the invention with reference to applications as a stand alone kiosk suitable for use in a store, a hotel, a mall or the like. The digital data archiving apparatus disclosed herein may also be used in a home for use by consumers who have digital recording devices and players but no computer. Other embodiments suitable for other applications will be apparent to those skilled in the art given the benefit of this disclosure.

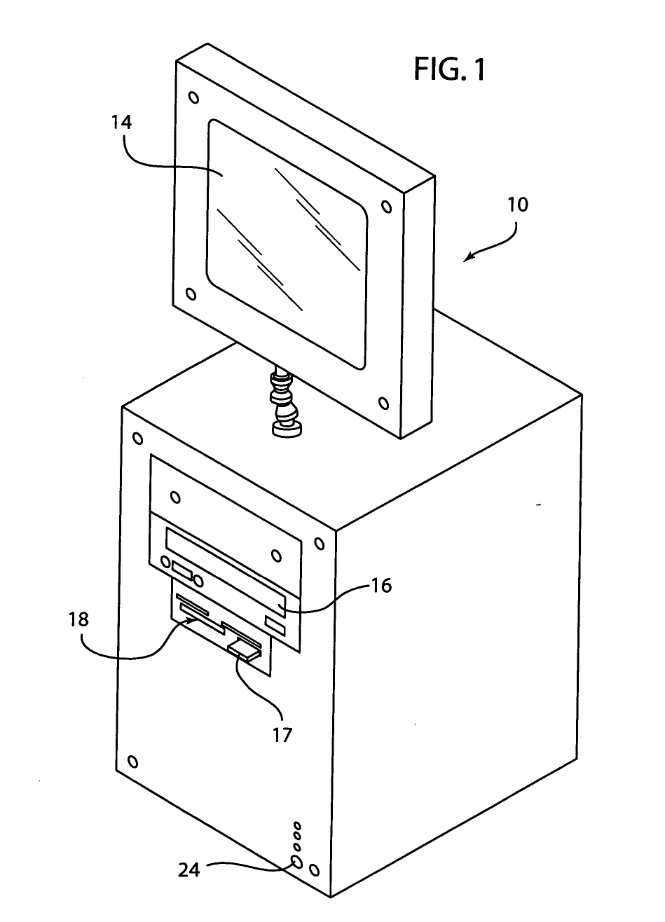

Turning now to the drawings, as seen in FIG. 1, a preferred embodiment of a digital data archiving apparatus 10 is provided. The apparatus 10 creates a backup for data stored on flash-memory cards of devices such as personal digital assistants (PDA's), portable music jukeboxes (MP3 players), digital cameras and camcorders, cell phones etc., transferring this digital data to a data storage device. The apparatus comprises a multi-card (or flash-memory) reader/writer unit 18, a compact disk and/or DVD reader/writer (CD/DVD-RW) 16 which transmits and copies digital data to a data storage device such as a CD or DVD, and a display 14, such as a liquid crystal display, TV, etc. Also provided are a hard disk drive, dual data rate memory and a central processing unit (CPU) mounted on a motherboard that includes video, sound and multiple audio/visual inputs and outputs. The motherboard can provide a video NTSC compatible signal to the LCD display 14 unit as well as a SVGA signal that may be used in certain preferred embodiments. The apparatus would preferably run on alternating current (AC) and be turned on at power button 24. Optionally, the apparatus may be provided with an internal 12V power supply such as a battery, and may have a DC to AC converter.

It will be readily apparent to those skilled in the art, given the benefit of this disclosure, that the digital data archiving apparatus may be adapted to incorporate many variations in the fields of flash-memory card readers/writers and the memory cards themselves. For example, as shown in FIG. 1, four different ports are provided, adapted to receive multiple cards, for example, compact flash type I and II, and micro drive; compact flash to xd adapters; smart media; secure digital; multimedia card; memory stick and memory stick pro; and with an adapter, memory stick duo and duo pro. The same variety of choices is true of the data copying and storage devices. For example, the data storage device can comprise one of a CD, DVD-R, DVD+R, Single and Double sided and layered DVD-R and DVD+R etc.

In accordance with a high advantageous feature of at least certain preferred embodiments, the digital data archiving device copying occurs directly in the sense that there is no keyboard, mouse, touch screen or any other operator input device requiring an input from the operator. The apparatus merely provides visual prompts to the operator to carry out the next required step to complete the task of archiving digital data to the digital data storage device and the data is directly copied, first from the memory card to the hard drive, and then, from the hard drive to the data storage device (CD/DVD).

The method of archiving digital data using this apparatus begins with powering up by pressing the power button 24 and inserting a startup/shutdown card 17 (shown in FIG. 1). The startup card can preferably contain several useful modules; such as a diagnostic module; an accounting module; and an advertising module, each comprising software that provides instructions to the apparatus 10. Software may also reside on the apparatus proper, and may interact and compliment the software on the startup/shutdown card 17. The diagnostic module software checks to see if it has been damaged. Diagnostic module software may also reside on the hard drive to check if the hard drive or the operating system software residing on the hard drive has been damaged. If the diagnostic software on the card detects that the software of the startup/shutdown card 17 been damaged, then the software can replace any defective code. Similarly, if the diagnostic software on the hard drive detects that the software of the operating system has been damaged, the software repairs the operating system and itself to its original condition before continuing the startup (boot) process. The diagnostic module may also preferably be provided with a hardware self-check function that prevents the system to power up completely if a hardware problem is detected.

Once all startup (boot) processes have been completed the system is in a wait mode. The software may check the flash-memory card reader/writer for any activity as well as the data copying device for any proprietary files or folders to update the operating system or introduce any new or updated messages to be displayed by the display unit.

In accordance with a highly advantageous feature, the software may also process and display files used to either display messages or prompts on the display 14 such as enticements to use the apparatus or advertisement for other products, or provide for copying of advertisements that would be transferred directly to each data recordation device. These files may either be included with as part of the advertisement module with the startup/shutdown card 17 or included as a separate CD. All of this can be done in addition to supplying visual prompts for the user to insert a flash-memory card and complete the archiving of data.

The accounting module may be provided in the software, and can be present on the startup/shutdown card 17. The accounting module tracks the time and date, number of flash memory cards inserting into the apparatus, total number of megabytes of data copied from the flash-memory card(s) to the hard drive, the number of times a CD/DVD is created from the copied digital data, plus any other tracking data which a provider of the card 17 (such as a lessee) may require to maintain system quality and accounting. This allows the operator to remit to the seller/licensor or franchisor to receive appropriate payment. Preferably the apparatus is designed so that it will not function without the startup/shutdown card 17. In one preferred embodiment, the startup/shutdown card is designed to expire after a period of time, for example, quarterly. The cards can be collected and any accounting information present can be verified.

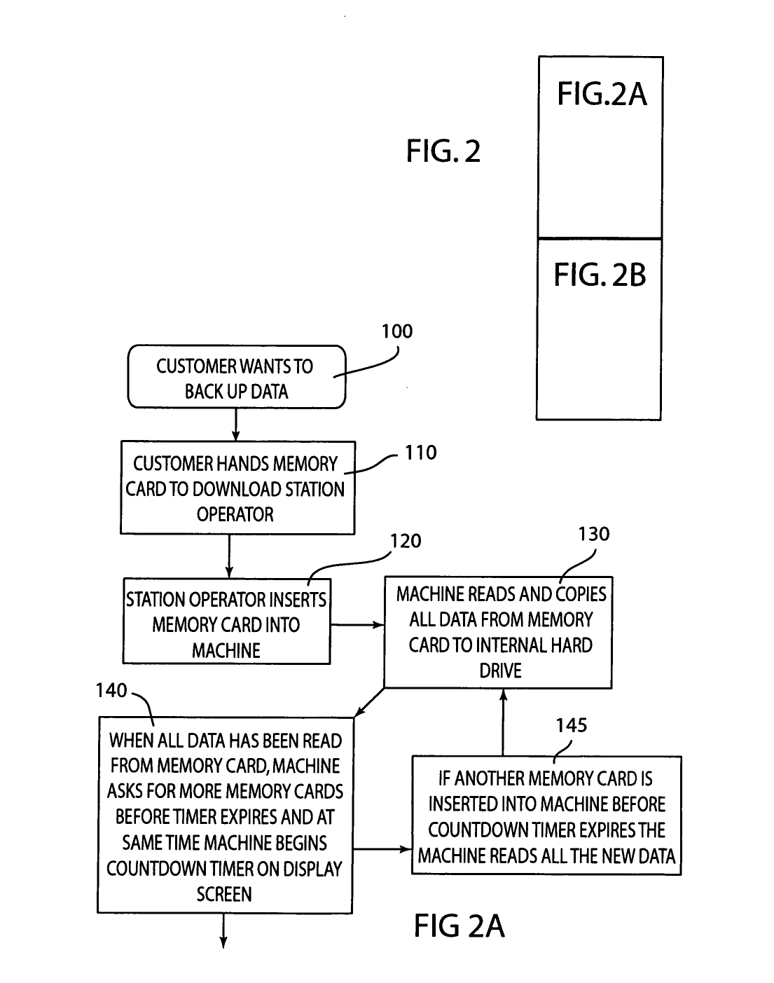

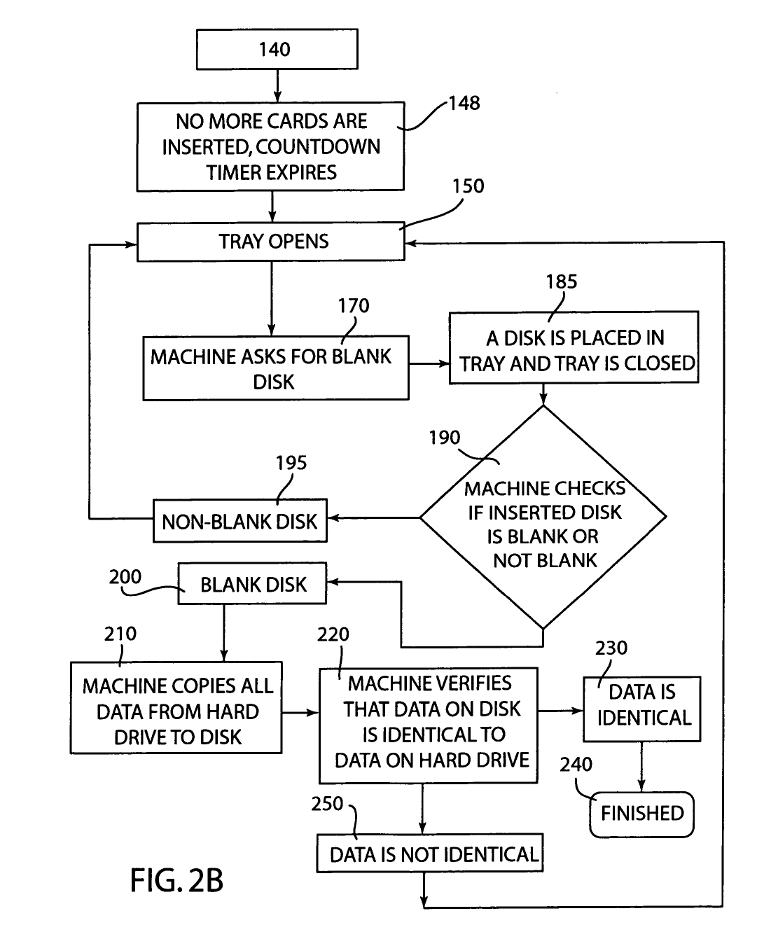

FIGS. 2, 2A and 2B show a preferred method of archiving digital data. When the apparatus 10 is on and ready to go (i.e., when the display 14 provides a command such as “Please Insert A Card”) and a customer wishes to archive his digital data, such as copy digital photos from his camera to a backup CD, the customer would hand the memory card from their camera to a station operator 110. The operator would insert one of the many supported memory cards into the flash memory read/writer 18 at step 120.

When a flash-memory card is inserted into its respective opening in the machine 10, the software checks it to see if it has any proprietary information on it to process. If there is a proprietary instruction set or process on the card it is then immediately executed unless the system is told by the instruction set to delay the action until a specific later date or time. If there are no proprietary instructions or processes on the flash-memory card then the system begins to copy all of the data from the flash-memory card to the systems internal hard disk drive. At the same time a status bar indicator may be displayed on the display 14 to give a general representation of the state of progress of copying the digital data to its internal hard disk drive. All of the data on the flash-memory card is read and copied via the flash-memory card reader/writer unit regardless of type or formatting of the data, including any outside proprietary machine or software instructions and copies them all, including any special formatting properties or file allocation properties on the card so that an exact duplicate of the data on the inserted card can be written to the systems internal hard disk drive and then written (burned) to the blank CD or DVD disk. Step 130. Once all of the digital data has been copied the displayed status bar (if present) may optionally scroll across the display 14 to indicate that the file copying process for the currently inserted flash-memory card has been completed and that the apparatus is ready to accept more flash-memory cards, (Step 140) as long as a predetermined limit in megabytes has not been reached or exceeded.

When all card data has been read the display 14 prompts the user to insert another card before the status bar returns to its original position. If the data that has been read is a plurality of files that are of a format that can be decoded and displayed by the system, then a sampling of those files may be displayed on the screen 14. Optionally the apparatus may be set up to receive multiple memory cards prior to copying onto the data storage device. If another flash-memory card is inserted (step 145) before the status bar returns to its starting position then step 130 repeats. This can happen until the system has reached its predetermined input limit. The input limit can be set by the amount of data transferred to the hard drive and can be based on the amount of data that can be transferred to one data storage device. Thus, for example, the input limit could be controlled by the amount of data which could be transferred to a CD or DVD, minus any space for advertising or other messages. Once the operator has removed the flash-memory card from the flash-memory card reader\writer unit another status bar is displayed on the display 14 as a countdown timer while waiting a predetermined period of time for more flash-memory cards to be inserted by the operator before it reaches its starting position on the display. If the software detects that there has been another flash-memory card inserted into the reader\writer unit step 130 begins again.

Flash-memory cards may be inserted for copying before an internal countdown timer has reached expired (Step 148), assuming that the predetermined limit of data has not yet been reached. Optionally, the countdown timer may be presented on the display 14. Once all the digital data has been copied to the hard drive, the software opens a drive door or port of the data copying device 16 (Step 150) and a message or other prompt can be sent to the display 14 to prompt the operator to insert a blank CD (or DVD disk) into a tray of the port. Step 170. The operator inserts a data storage device, the tray is closed (Step 185), and the software begins the process of copying all of the data read from the card(s) to the CD or DVD disk. The software performs a diagnostic check to determine that the data recording device or disk inserted is in fact blank (Step 190); if it is not blank (step 195) then the tray opens again and the machine displays the message asking for a blank disk. Once a blank CD (or DVD disk) has been inserted (step 200) and the door closed the software begins the process of organizing the flash-memory card copied files, folders and directories to be burned (copied) to the blank CD (or DVD disk). Once all the digital data has been compiled the software instructs the CD-RW (or DVD-RW) to begin the burning (copying) process. Step 210. A message such as “burning CD” may be displayed. Note that the copying of the digital data still occurs directly even with the intermediate diagnostic step of checking to make sure that the data storage device is blank in the sense that no additional operator input is required for the copy of digital data from the hard drive to the data storage device.

When the apparatus has finished burning (copying) all of the data it had read from the previously inserted flash-memory card(s) to the blank CD (or DVD disk) a verification is made that all of the data on the CD or DVD disk is an exact duplicate of the data read from the flash-memory cards. Step 220. If the data is identical (Step 230) the process is complete (step 240). If the verification process fails (Step 250) then the process repeats; the tray opens and the operator is prompted to insert another blank disk.

The CD (or DVD disk) with all of the customer's data is presented to the operator by the tray opening for the last time and the display changing to show the initial message. At this point the operator can place the disk in a protective cover and release the completed disk to the customer in exchange for payment. Alternatively, the disks can be distributed for promotional purposes with advertising included on each disk to help support the costs of the apparatus 10 and disks.

At the end of a period of time, such as an end of a day, the startup/shutdown flash-memory card 17 would be reinserted. The software on the card 17 shuts down all processes and power off the system. The “shutdown” flash-memory card accounting module also instructs the software to upload to it (the flash-memory “shutdown” card) accounting and other tracking data indicating how many copies were made before completing the shutdown or power down sequences.

The various prompts which can be presented on the display 14 can comprise the following: Please Insert A Card; Downloading Data; Please Remove Card; Insert Another Card Before Timer Expires; Please Insert Disk; Burning Disk; Reloading; and Verifying Data. Other suitable messages for presentation on the display will readily apparent to those skilled in the art given the benefit of this disclosure, such as audio prompts or other non-text visual images or prompts in languages other than English.

From the foregoing disclosure and detailed description of certain preferred embodiments, it will be apparent that various modifications, additions and other alternative embodiments are possible without departing from the true scope and spirit of the invention. The embodiments discussed were chosen and described to provide the best illustration of the principles of the invention and its practical application to thereby enable one of ordinary skill in the art to use the invention in various embodiments and with various modifications as are suited to the particular use contemplated. All such modifications and variations are within the scope of the invention as determined by the appended claims when interpreted in accordance with the breadth to which they are fairly, legally, and equitably entitled.

1. A digital data archiving apparatus comprising, in combination:
a hard drive;
a flash memory reader/writer adapted to read digital data on a memory card and copy the digital data onto the hard drive;
a data recording device adapted to receive the digital data and copy the data to a data storage device; and
a display which presents messages including a first message to insert a memory card into the flash memory reader/writer and a second message to insert a data storage device into the data recording device;
wherein the first message is presented on the display and in response to the first message a memory card is inserted into the flash memory reader/writer and the digital data is directly copied to the hard drive, and then the second message is presented on the display and in response to the second message a data storage device is inserted into the data recording device and the digital data is directly copied to the data storage device.

2. The digital data archiving device of claim 1 wherein the data storage device is one of a CD, DVD-R, DVD+R, Single, Double sided and layered DVD-R, and DVD+R.

3. A method of archiving digital data using a digital data archiving apparatus comprising, in combination, the steps of:
inserting a memory card containing digital data into a flash memory reader/writer;
directly copying the digital data onto a hard drive;
inserting a data storage device into a data recording device; and
directly copying the digital data from the hard drive to the data storage device.

4. The method of claim 3 further comprising
prior to directly copying digital data onto the hard drive,
inserting a startup/shutdown card into the flash memory reader/writer and
providing power to the digital data archiving apparatus

5. The method of claim 4 wherein the digital data cannot be copied to the hard drive unless the startup/shutdown card has been inserted into the flash memory reader/writer.

6. The method of claim 5 wherein the startup/shutdown card expires after a predetermined period of time, after which digital data cannot be copied to the hard drive.

7. A method of archiving digital data using a digital data archiving apparatus comprising, in combination, the steps of:
inserting a memory card containing digital data into a flash memory reader/writer;
copying the digital data onto a hard drive;
inserting a data storage device into a data recording device;
copying the digital data from the hard drive to the data storage device; and
copying advertising onto the data storage device.

8. The method of archiving digital data of claim 7 further comprising
a display, wherein advertising is presented on the display.

9. The method of archiving digital data of claim 8 further comprising
a startup/shutdown card having an advertising module which contains the advertising to be presented on the display.

10. The method of archiving digital data of claim 7 further comprising
a startup/shutdown card having an advertising module which contains the advertising to be copied to the data storage device.

11. A method of archiving digital data using a digital data archiving apparatus comprising, in combination, the steps of:
inserting a memory card containing digital data into a flash memory reader/writer;
copying the digital data onto a hard drive;
inserting a data storage device into a data recording device;
copying the digital data from the hard drive to the data storage device;
creating information corresponding to the number of times digital data is copied; and
recording the information on a removable startup/shutdown card.

12. The method of archiving digital data of claim 11 wherein the startup/shutdown card contains an accounting module which records the information corresponding to the number of times digital data is copied.
